(19) United States
(12) Patent Application Publication
(10) Pub. No.: US 2010/0093596 A1
(43) Pub. Date: Apr. 15, 2010

(54) ULTRA-CONCENTRATED LIQUID DEGREASER COMPOSITION

(75) Inventor: Tami J. Tadrowski, Hillsborough, NC (US)

Correspondence Address: ECOLAB INC., MAIL STOP ESC-F7, 655 LONE OAK DRIVE, EAGAN, MN, 55121, US

(73) Assignee: ECOLAB INC., St. Paul, MN (US)

(21) Appl. No.: 12/418,898

(22) Filed: Apr. 6, 2009

Related U.S. Application Data
(60) Provisional application No. 61/042,909, filed on Apr. 7, 2008.

(51) Int. Cl. C11D 3/30

(52) U.S. Cl. 510/365

(57) ABSTRACT

A substantially nonaqueous concentrate composition is provided comprising an amine oxide surfactant, a water-soluble solvent, a source of alkalinity, a chelating agent and a hydrotrope wherein the concentrate composition is useful in preparing a stable, aqueous totally water soluble solution. The composition may optionally include any one or combination of a nonionic surfactant, anionic surfactant, a corrosion inhibitor, dye, perfume, or preservative. The ultra-concentrated composition of the invention is uniquely suited for multiple delivery methods including coating on a substrate before dilution, or adding the liquid concentrate directly to the diluent.

### RELATED APPLICATIONS

This application claims priority under 35 U.S.C. §119(e) to U.S. Provisional Application entitled “Ultraconcentrated Degreaser Composition for Use With Various Delivery Methods,” Ser. No. 61/042,909, filed on Apr. 7, 2008, which is incorporated herein by reference in its entirety for all purposes.

### FIELD OF THE INVENTION

The present invention is directed to compositions for the treatment of hard surfaces. The present invention relates to hard surface cleaning compositions, especially compositions that are ultra-concentrated, and dissolve and disperse satisfactorily in water and exhibit excellent stability and degreasing ability.

### BACKGROUND OF THE INVENTION

Liquid cleaning compositions comprising surfactants are known. Such compositions can be used, for example, as hard surface cleaners, in either dilutable form or in ready-to-use form which in addition to providing a useful detersive effect also provide a degreasing effect to a treated hard surface. Such compositions do not generally have any compatibility problems when being diluted with a large quantity of water.

For some purposes it is desirable to have liquid degreasing compositions that are anhydrous or substantially anhydrous. In some instances, when such compositions are anhydrous or substantially anhydrous, pre-measured doses can be prepared so that the user of these compositions do not have to measure the appropriate amount of surfactant composition to use every time they wish to clean hard surfaces.

Thus, there is real and continuing need in the art for improved compositions that are useful in the cleaning of surfaces, particularly hard surfaces, and more particularly in providing degreasing abilities. There is a real and continuing need in the art for improved hard surface treatment compositions which provide a cleaning benefit and which overcomes one or more of the shortcomings of prior art hard surface cleaning compositions. Particularly, there is a need for further improved hard surface cleaning compositions which are provided in an ultra-concentrated format, dissolve quickly in water, mitigate irritation of the skin and eyes, and are not corrosive to soft metals such as aluminum.

The diluted use compositions are suitable for application to soiled surfaces for a sufficient period of time to loosen and remove any organic or greasy soil deposits from hard surfaces. The common target soil comprises combined organic/inorganic soils having a large organic component such as oils, fats, and other substantially aqueous insoluble organic media.

### BRIEF DESCRIPTION OF THE DRAWINGS

### Summary of the Invention

The present inventive concentrate composition is especially suitable for liquid concentrates where the liquid concentrate is coated on a substrate and the substrate is simply added to a large quantity of water and the concentrate releases from the substrate. The favorable dissolution and dispersion properties of the concentrate compositions according to the present invention are particularly useful in this context. The present inventive concentrate compositions are suitable for use in a container where the substrate containing a measured quantity of the concentrate composition is simply added to a premeasured quantity of water and goes into solution. The substrate may either remain in the use composition, or may dissolve and disappear once a diluted treatment composition (use composition) is formed. The favorable dissolution and dispersion properties of the concentrate composition of the present invention are particularly useful in this context.

In an alternate embodiment, the present inventive liquid concentrate composition is especially suitable for use in a water-soluble container where the container is simply added to a large quantity of water and dissolves, releasing its contents. The favorable ultra-compact nature, and dissolution and dispersion properties of the concentrate compositions according to the present invention are particularly useful in this context. The present inventive concentrate compositions are suitable for delivery from a packet, bottle, cartridge, jug, bag, pouch, pail, bucket, or drum where a specified amount of concentrate is measured and then simply added to a premeasured quantity of water and dissolves forming a use composition. The present inventive concentrate compositions are also suitable for diluting through dispensing equipment with an aspirator to deliver a specified dose rate of concentrate to a stream of service water to form the desired use solution composition. Other dispensing options for the present inventive concentrate include peristaltic pumps and gear pumps. The present inventive concentrate can also be filled in a multi-chambered or single chambered cartridge for insertion into spray bottles, hose end sprayers, garden sprayers and the like. The present inventive composition can also be diluted at the manufacturing site and delivered as a packaged ready-to-use cleaning solution.

In one aspect, the invention involves using compositions of the invention as a concentrate in a fully formulated product that is used in aqueous solution for complex organic or greasy soil and inorganic soil removal. In such applications, the composition of the invention is combined in an aqueous solution and is designed for removing soil from a particular substrate. Such substrates include common hard surfaces. Such hard surfaces can exist in food preparation applications, restaurants, grocery stores, the household, offices, nursing homes, day cares, hospitals and other locations where food soils or other greasy soils can accumulate on hard surfaces. Such surfaces can be cleaned using a formulated hard surface cleaner that includes the composition of the invention as a degreasing or organic soil removing component.

In one aspect, the invention involves using compositions of the invention as a concentrate suitable for dilution with water to prepare a fully formulated product that is used for complex organic or greasy soil and inorganic soil removal. In such applications, the composition of the invention is combined with water to prepare a use composition or use solution and is designed for removing soil from a particular substrate.

The stable concentrated cleaning compositions of the invention particularly suited for delivery on a substrate comprise about 5 to 80% by weight of an amine oxide surfactant, about 0.05 to 80 wt % of a water soluble solvent (preferably glycol ether), about 0.05 to 40 wt % of a source of alkalinity, the weight ratio of the amine oxide to the water soluble solvent is such that there are between about 10 to about 1 parts by weight, preferably about 5 to 1 parts of the amine oxide per each one part by weight of the water soluble solvent, and optionally about 0 to 30% by weight of one or more effective hydrotrope solubilizers, preferably a dipropionate, a polyethylene glycol (PEG) or a polypropylene glycol (PPG) to stabilize an optional chelating agent and optional corrosion inhibitor, the water soluble solvent, and the surfactants in a uniform single phase aqueous composition before dilution with water. The concentrate composition of the invention comprises about 0.05 to 40% by weight of an alkalinity source (preferably an amino methyl propanol). A combination of two optional chelating agents may be added to the composition in the total amount of from about 0 to 30 wt % (preferably ethanoldiglycinate, disodium salt, “EDG” and methylglycine-N—N diacetic acid trisodium salt, “MGDA”). When chelating salts are added, a combination of two chelators is preferred to prevent crystal formation. Without being bound by theory, it is believed that the molecular structure of one of the chelators prevents the other chelating salt from forming a crystalline precipitate. Optionally, about 0 to 40 wt % of a nonionic surfactant (preferably an alcohol alkoxylate) is included in the composition.

In another embodiment, the stable concentrated cleaning compositions of the invention particularly suited for delivery on a substrate comprise about 0.05 to 30% by weight of an amine oxide surfactant, about 0.05 to 80 wt % of a water soluble solvent (preferably glycol ether), about 0.05 to 40 wt % of a source of alkalinity, the weight ratio of the water soluble solvent to the amine oxide is such that there are between about 1 to about 10 parts by weight, preferably about 1 to 5 parts of the water soluble solvent per each one part by weight of the amine oxide. The concentrate composition of the invention comprises about 0.05 to 40% by weight of an alkalinity source (preferably an amino methyl propanol). Optionally, about 0 to 40 wt % of a nonionic surfactant (preferably an alcohol alkoxylate) is included in the composition. Dyes and fragrances are also optionally included in compositions of the invention. This embodiment is substantially free of water.

In another view of the stable liquid concentrate compositions of the invention particularly suitable for coating on a substrate, the composition can comprise about 0 to 30% by weight of a water-soluble solvent, preferably glycol ether, about 5 to about 80 wt % of one or more amine oxide surfactant, about 0.05 to 40% by weight of an alkaline source (preferably an amino methyl propanol) and when a chelating agent is optionally included about 0 to 30 wt % of one or more hydrotropes, preferably a dipropionate, polyethylene glycol (PEG) or polypropylene glycol (PPG) material. In these compositions, the ratio between the source of alkalinity and the amine oxide is such that there are about 1 to 15 parts by weight of the amine oxide per each part by weight of the alkalinity source. In these compositions, the ratio between the source of alkalinity and the solvent is about 1 part by weight of the alkalinity source per each part by weight of the solvent. Optionally, about 0 to 40 wt % of one or more nonionic surfactants (preferably an alcohol alkoxylate) is included in the composition. This balance of materials in the composition provides a substantially nonaqueous cleaning concentrate having enhanced cleaning properties when diluted in water. This composition is substantially soluble in water. This composition of the invention is particularly well suited for coating on a substrate, is maintained in a single phase before dilution with water, and dissolves well and easily disperses from the substrate when placed in water.

A substantially non-aqueous stable concentrate for use in preparing a stable, aqueous cleaner/degreaser liquid composition in the form of a totally water soluble solution easily coated on a substrate that is readily releasable from the substrate is provided comprising 0.05 to 80 wt % of a substantially water soluble solvent, 5 to 80 wt % of an amine oxide, 0.05 to 40 wt % of an alkalinity source and optionally 0 to 30 wt % of a hydrotrope along with 0 to 30 wt % of a blend of optional chelating agents, 0 to 40 wt % of an optional nonionic surfactant, and optionally up to about 0.45 wt % additional water when an optional corrosion inhibitor of up to about 0.05% is added. Additionally, any combination of a preservative, fragrance, or dye is optionally added.

A stable liquid concentrate, having a shelf life of up to two years, for use in preparing a stable, aqueous cleaner/degreaser liquid composition in the form of a totally water soluble solution is provided comprising 0.01 to 60 wt % of a substantially water soluble solvent, 2 to 90 wt % of an amine oxide, 0.05 to 50 wt % of an alkalinity source and optionally 0 to 50 wt % of a hydrotrope along with 0 to 40 wt % of a blend of optional chelating agents, 0.05 to 50 wt % of a nonionic surfactant, and optionally up to about 3.6 wt % additional water when an optional corrosion inhibitor of up to about 0.4% is added. Depending upon the concentration of the composition, up to about 10 weight % water is added, up to about 8 weight percent water, up to about 6 weight percent water, up to about 4 weight percent water, up to about 2.5 weight percent water and up to about 1 weight percent water. Water is added to allow ease of dispensing and ease of flow. In some embodiments, the composition of the invention is substantially free of water. Additionally, any combination of a preservative, fragrance, or dye is optionally added.

### DETAILED DESCRIPTION OF THE INVENTION

The composition of the invention is unique in that it is suitable for different delivery methods. These delivery methods include liquid delivery and coating on a nonwoven substrate. Liquid delivery includes but is not limited to coating a substrate with the concentrated liquid composition for dilution with a premeasured amount of water. Liquid delivery further includes delivering the free liquid concentrate to a premeasured amount of diluent to form a use composition. Liquid delivery can also encompass prediluted compositions resulting in a ready to use formulation.

Each of the delivery methods is summarized below followed by a more exhaustive explanation of the components of the composition.

For the following defined terms, these definitions shall be applied, unless a different definition is given in the claims or elsewhere in this specification.

As used herein the term “substrate delivery” or “delivery on a substrate” refers to an embodiment of the invention when the composition is a liquid and contains very little, if any added water. As used herein, the term “substrate” can refer to any material suitable for delivery of a cleaning composition including but not limited to nonwoven webs, woven materials, polymers (whether water-soluble or not), to name a few. Before coating on a substrate, compositions suitable for substrate delivery exhibit a shelf life of up to about 24 hours before any salt precipitates out of solution. Once coated on the substrate, such compositions exhibit a much extended shelf life of up to about 6 months, up to about 1 year, and up to about 2 years.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

Weight percent, percent by weight, % by weight, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

The term “alkyl” refers to a straight or branched chain monovalent hydrocarbon radical having a specified number of carbon atoms. Alkyl groups may be unsubstituted or substituted with substituents that do not interfere with the specified function of the composition and may be substituted once or twice with the same or different group.

Substituents may include alkoxy, hydroxy, mercapto, amino, alkyl substituted amino, nitro, carboxy, carbanoyl, carbanoyloxy, cyano, methylsulfonylamino, or halo, for example. Examples of “alkyl” include, but are not limited to, methyl, ethyl, n-propyl, isopropyl, n-butyl, s-butyl, t-butyl, n-pentyl, n-hexyl, 3-methylpentyl, and the like.

The term “alkoxy” refers to a straight or branched chain monovalent hydrocarbon radical having a specified number of carbon atoms and a carbon-oxygen-carbon bond, may be unsubstituted or substituted with substituents that do not interfere with the specified function of the composition and may be substituted once or twice with the same or different group. Substituents may include alkoxy, hydroxy, mercapto, amino, alkyl substituted amino, nitro, carboxy, carbanoyl, carbanoyloxy, cyano, methylsulfonylamino, or halo, for example. Examples include methoxy, ethoxy, propoxy, t-butoxy, and the like.

The terms EO, PO, or EO/PO as used herein refer to ethylene oxide and propylene oxide, respectively. EO/PO refers to ethylene oxide and propylene oxide block copolymers.

The term “stable” as used herein refers to a composition or solution that remains in a single phase and does not phase separate when subjected to accelerated or extended storage conditions. The term “stable” further refers to a composition or solution that does not form crystals or precipitate when stored for an extended period. Such an extended period is at least about 1 week, at least about 2 weeks, at least about 3 weeks, at least about 4 weeks, at least about 6 weeks, at least about 2 months, at least about 3 months, at least about 4 months, at least about 5 months, at least about 6 months, at least about 1 year, at least about 18 months, at least about 21 months, at least about 2 years. The term “stable” encompasses each timeframe (by weeks or months) up to about 2 years although it may not be expressly listed herein.

The term “surfactant” or “surface active agent” refers to an organic chemical that when added to a liquid changes the properties of that liquid at a surface.

The term “substantially free” may refer to any component that the composition of the invention lacks or mostly lacks. When referring to “substantially free” it is intended that the component is not intentionally added to compositions of the invention. Use of the term “substantially free” with respect to a component allows for trace amounts of that component to be included in compositions of the invention because they are present in another component. However, it is recognized that only trace or de minimus amounts of a component will be allowed when the composition is said to be “substantially free” of that component.

Unless otherwise stated, all weight percentages provided herein reflect the weight percentage of the raw material as provided from the manufacturer. The active weight percent of each component is easily determined from the provided information by use of product data sheets as provided from the manufacturer.

### Liquid Composition Suitable for Coating on a Substrate

Coating a substrate with a liquid concentration for delivery to a premeasured amount of diluent provides particular problems when formulating a degreaser concentrate. The formulation must be ultraconcentrated because any given substrate will accept and support only a finite amount of a concentrate. A further challenge is that the concentrate composition must readily release from its substrate carrier and dilute in the premeasured diluent.

A first liquid composition suitable for coating on a substrate such as a non-woven strip is provided. In such a concentrated formula, an amine oxide blend, an alkalinity source, an alcohol alkoxylate (nonionic) surfactant, and a water-soluble solvent are included. The water-soluble solvent provided as glycol ether helps to speed the dissolution of the concentrate from the substrate into the diluent. Alternate embodiments optionally include a chelant and a hydrotrope, a corrosion inhibitor diluted in water, preservative, fragrance, and/or dye. The liquid concentrate, is diluted in water to about 1:300 by weight, from about 1:25 to about 1:250 by weight, and from about 1:50 to about 1:200 by weight.

### Liquid Composition Suitable for Coating on a Substrate—Alternative Embodiment

An alternate composition is provided suitable for coating on a substrate such as a non-woven strip. In such a concentrated formula, an amine oxide blend, an alkalinity source, a sequestrant, a hydrotrope, and a water-soluble solvent are included. In an embodiment a blend of sequestrants or a blend of hydrotropes may be useful. A corrosion inhibitor diluted in water, non-ionic surfactants, preservative, fragrance, and/or dye are optional. As in the previous embodiment, the glycol ether aids in the dissolution of the concentrate from the substrate into the diluent. The liquid concentrate, is diluted with water to about 1:300 by weight, from about 1:25 to about 1:250 by weight, and from about 1:50 to about 1:200 by weight.

The table below provides component ranges for the liquid substrate delivery embodiment concentrated degreaser of the invention. Such a concentrate is preferably coated on a substrate for dilution in water.

| Tradename | Weight % | Chemical Name |
|---|---|---|
| Lonza Barlox 1260* | 5-80% | N-N Dimethyl-1-lauryl |
| | | amine-N-oxide, 60%* |
| Sodium Metasilicate | 0-0.4% | Sodium Metasilicate |
| Pentahydrate | | Pentahydrate |
| Unger AMP-95, 95% | 0.05-40% | 2-amino-2-methyl-1- |
| | | propanol, 95% solution |
| Rhodia Mirataine H2C-HA/ | 0-30% | Sodium Laurimino |
| McIntyre Mackam168L | | Dipropionate, 29.5% |
| | | solution |
| Clariant Polyglykol 200 | 0-20% | Polyethylene glycol 200 |
| | | molecular weight |
| DOW PT-250 | 0-20% | Polypropylene glycol 250 |
| | | molecular weight with 3 |
| | | terminal hydroxyl groups |
| Stepan Stepanate SXS, 40% | 0-25% | Sodium Xylene Sulfonate, |
| solution | | 40% solution |
| Diethylene Glycol Monobutyl | 0.05-80% | Diethylene Glycol |
| Ether | | Monobutyl Ether |
| Water | 0-36% | Water |
| Perfume, Orange | 0-5% | |
| Dye, Liquid | 0-5% | |
| Akzo Nobel EDG/DOW | 0-30% | Disodium ethanol |
| HEIDA | | diglycinate, 28% solution |
| BASF Trilon M (MGDA), | 0-30% | Methylglycine-N-N |
| 40% solution | | diacetic acid trisodium salt |
| | | (MGDA), 40% solution |
| BASF Plurafac LF 901 | 0-40% | Long Chain Alcohol |
| | | Alkoxylate |

*Note: Barlox 1260 is a mixture of 3 amine oxides in water and polypropylene glycol. Barlox 1260 contains: 41.4% Dimethyl lauryl amine oxide, 15% Dimethyl myristyl amine oxide, 3.6% Dimethyl cetyl amine oxide, 25% polypropylene glycol (CAS# 25322-69-4) and 15% water.

Liquid Composition for Dilution without Substrate Delivery

A concentrated degreaser composition is provided which is diluted with water without requiring coating on a substrate. This composition may be provided as a concentrate and be diluted with water at the customer's site or may be offered as a ready-to-use composition. In such a concentrated degreaser formula, an amine oxide blend, an alkalinity source, a sequestrant, a hydrotrope, and a long chain alcohol alkoxylate (nonionic) surfactant are included. In other embodiments a combination of sequestrants or a combination of hydrotropes may be useful. A corrosion inhibitor such as metasilicate, water, and water soluble glycol ether solvent are optional. A liquid concentrate according to this embodiment can be diluted in water to about 1:300 by weight, from about 1:25 to about 1:250 by weight, and from about 1:50 to about 1:200 by weight.

The table below provides component ranges for the concentrated degreaser liquid embodiment of the invention. The concentrate is preferably not coated on a substrate.

| Tradename | Weight % | Chemical Name |
|---|---|---|
| Lonza Barlox 1260 | 2-90% | N-N Dimethyl-1-lauryl |
| | | amine-N-oxide, 60% |
| Sodium Metasilicate | 0-0.4% | Sodium Metasilicate |
| Pentahydrate | | Pentahydrate |
| Unger AMP-95, 95% | 0.05-50% | 2-amino-2-methyl-1- |
| | | propanol, 95% solution |
| Rhodia Mirataine H2C-HA/ | 0-50% | Sodium Laurimino |
| McIntyre Mackam168L | | Dipropionate, 29.5% solution |
| Clariant Polyglykol 200 | 0-30% | Polyethylene glycol 200 |
| | | molecular weight |
| DOW PT-250 | 0-30% | Polypropylene glycol 250 |
| | | molecular weight with 3 |
| | | terminal hydroxyl groups |
| Stepan Stepanate SXS, 40% | 0-40% | Sodium Xylene Sulfonate, |
| solution | | 40% solution |
| Diethylene Glycol | 0.05-60% | Diethylene Glycol Monobutyl |
| Monobutyl Ether | | Ether |
| Water | 0-10.0% | Water |
| Perfume, Orange | 0-5% | |
| Dye, Liquid | 0-5% | |
| Akzo Nobel EDG/DOW | 0-40% | Disodium ethanol diglycinate, |
| HEIDA | | 28% solution |
| BASF Trilon M (MGDA), | 0-40% | Methylglycine-N-N diacetic |
| 40% solution | | acid trisodium salt (MGDA), |
| | | 40% solution |
| BASF Plurafac LF 901 | 0.05-50% | Long Chain Alcohol |
| | | Alkoxylate |

### Source of Alkalinity

Soil removal is most commonly obtained from a source of alkalinity used in manufacturing a cleaning composition or degreaser. Sources of alkalinity can be organic, inorganic, and mixtures thereof. Organic sources of alkalinity are often strong nitrogen bases including, for example, ammonia (ammonium hydroxide), amines, alkanolamines, and amino alcohols. Typical examples of amines include primary, secondary or tertiary amines and diamines carrying at least one nitrogen linked hydrocarbon group, which represents a saturated or unsaturated linear or branched alkyl group having at least 10 carbon atoms and preferably 16-24 carbon atoms, or an aryl, aralkyl, or alkaryl group containing up to 24 carbon atoms, and wherein the optional other nitrogen linked groups are formed by optionally substituted alkyl groups, aryl group or aralkyl groups or polyalkoxy groups. Typical examples of alkanolamines include monoethanolamine, monopropanolamine, diethanolamine, dipropanolamine, triethanolamine, tripropanolamine and the like. Typical examples of amino alcohols include 2-amino-2-methyl-1-propanol, 2-amino-1-butanol, 2-amino-2-methyl-1,3-propanediol, 2-amino-2-ethyl-1,3-propanediol, hydroxymethyl aminomethane, and the like.

Additional detergency can be obtained from the use of surfactant materials. Typically, anionic or nonionic surfactants are formulated into such detergents with other ingredients to obtain compositions that can be used to form cleaning solutions having substantial soil removal while controlling foam action. A number of optional detergent ingredients can enhance soil removal, but primarily soil removal is obtained from the alkalinity source and the anionic or nonionic surfactant.

In an embodiment for delivery on a substrate, an amino alcohol such as 2-amino-2-methyl-1-propanol commercially available as AMP-95 from Angus Chemical Company, a subsidiary of The Dow Chemical Company is useful. In an embodiment when coating on a substrate is desired, the source of alkalinity is present in an amount from about 0.05 to 40 weight percent, from about 1 to about 25 wt %, and from about 2 to 15 wt %.

In an embodiment for dilutable applications where delivery on a substrate is not necessary, an amino alcohol such as 2-amino-2-methyl-1-propanol commercially available as AMP-95 from Angus Chemical Company, a subsidiary of The Dow Chemical Company is also useful. In an embodiment when coating on a substrate is not desired, the source of alkalinity is present in an amount from about 0.05 to 50 weight percent, from about 1 to about 20 wt %, and from about 2 to 10 wt %.

### Amine Oxide

In addition to the source of alkalinity, an amine oxide surfactant works in conjunction with the alkaline source to work as the primary degreasing agents in the composition of the present invention.

Active ingredients such as surfactants or surface tension altering compounds or polymers are useful in the present invention. Specifically, surfactants function to alter surface tension in the resulting compositions, provide sheeting action, and assist in soil removal and suspension by emulsifying soil and allowing removal through a subsequent wiping, flushing or rinse. Any number of surfactants may be used including organic surfactants such as anionic surfactants, zwitterionic surfactants, amphoteric surfactants, cationic surfactants and nonionic surfactants. The cleaning agent can be a surfactant or surfactant system, also referred to as a surfactant admixture.

The surfactant or surfactant admixture of the invention includes a tertiary amine oxide. Typical examples of tertiary amine oxides include amine oxides having two C₁₋₅ alkyl groups and one larger C₆₋₃₀ alkyl group. Representative of such materials are dimethyl coco amine oxide, dimethyl lauryl amine oxide, dimethyl decyl amine oxide, dimethyl octyl amine oxide, dimethyl oleyl amine oxide, coco bis ethoxy amine oxide, tallow bis ethoxy amine oxide, bis(2-hydroxy ethyl) cetylamine oxide, bis(2-hydroxy ethyl) tallow amine oxide, bis(2-hydroxy ethyl)hydrogenated tallow amine oxide, bis(2-hydroxy ethyl) stearyl amine oxide, bis(2-hydroxy propyl) tallow amine oxide, bis(2-hydroxy propyl) stearyl amine oxide, dimethyl tallow amine oxide, dimethyl cetyl amine oxide, dimethyl myristyl amine oxide dimethyl stearyl amine oxide, and diethyl stearyl amine oxide. Most preferably the amine oxide blend is a blend of dimethyl lauryl amine oxide, dimethyl myristyl amine oxide, and dimethyl cetyl amine oxide. In an embodiment for delivery upon a substrate, dimethyl lauryl amine oxide commercially available as Barlox 1260 from Lonza Group is useful. Barlox 1260 is a mixture of 3 amine oxides in water and polypropylene glycol. Barlox 1260 contains 41.4% Dimethyl lauryl amine oxide, 15% Dimethyl myristyl amine oxide, 3.6% Dimethyl cetyl amine oxide, 25% polypropylene glycol and 15% water. In an embodiment for liquid delivery on a substrate, the amine oxide is present in the invention in an amount of about 5 up to about 80 percent by weight, about 10 up to about 75 wt %, and about 15 up to about 70 wt %.

In an embodiment for liquid delivery not coated upon a substrate, the surfactant or surfactant admixture of the invention also includes an amine oxide. In an embodiment for liquid delivery, dimethyl lauryl amine oxide commercially available as Barlox 1260 from Lonza Group is useful. The amine oxide is present in the invention in an amount of about 2 up to about 90 percent by weight, about 30 up to about 85 wt %, and about 50 up to about 80 wt %.

### Surfactant

In addition to the amine oxide, a nonionic surfactant or nonionic surfactant admixture is added to the invention concentrate for delivery methods including the substrate delivery. The particular surfactant or surfactant mixture chosen for use in the process and products of this invention can depend on the conditions of final utility, including method of manufacture, physical product form, use pH, use temperature, foam control, and soil type.

For the purpose of this patent application, the term “nonionic surfactant” typically indicates a surfactant having a hydrophobic group and at least one hydrophilic group comprising a (EO)ₓ group, a (PO)_{y} group, or a (BO)_{z} group wherein x, y and z are numbers that can range from about 1 to about 100. The combination of a generic hydrophobic group and such a hydrophilic group provides substantial surfactancy to such a composition. Examples of suitable types of nonionic surfactant include the polyethylene oxide condensates of alkyl phenols. These compounds include the condensation products of alkyl phenols having an alkyl group containing from about 6 to 12 carbon atoms in either a straight chain or branched chain configuration, with ethylene oxide. Ethylene oxide being present in amounts equal to 5 to 20 moles of ethylene oxide per mole of alkyl phenol. Examples of compounds of this type include nonyl phenol condensed with an average of about 9.5 moles of ethylene oxide per mole of nonyl phenol, dodecyl phenol condensed with about 12 moles of ethylene oxide per mole of phenol, dinonyl phenol condensed with about 15 moles of ethylene oxide per mole of phenol, diisoctylphenol condensed with about 15 moles of ethylene oxide per mole of phenol.

The condensation products of aliphatic alcohols with ethylene oxide can also exhibit useful surfactant properties. The alkyl chain of the aliphatic alcohol may either be straight or branched and generally contains from about 3 to about 22 carbon atoms. Preferably, there are from about 3 to about 18 moles of ethylene oxide per mole of alcohol. The polyether can be conventionally end capped with acyl groups including methyl, benzyl, etc. groups. Examples of such ethoxylated alcohols include the condensation product of about 6 moles of ethylene oxide with 1 mole of tridecanol, myristyl alcohol condensed with about 10 moles of ethylene oxide per mole of myristyl alcohol, the condensation product of ethylene oxide with coconut fatty alcohol wherein the coconut alcohol is a mixture of fatty alcohols with alkyl chains varying from 10 to 14 carbon atoms and wherein the condensate contains about 6 moles of ethylene oxide per mole of alcohol, and the condensation product of about 9 moles of ethylene oxide with the above-described coconut alcohol. Examples of commercially available nonionic surfactants of this type include Tergitol 15-S-9 marketed by DOW and Tomadol 91-6 marketed by Air Products.

The condensation products of ethylene oxide with a hydrophobic base formed by the condensation of propylene oxide with propylene glycol can be used. The hydrophobic portion of these compounds has a molecular weight of from about 1,500 to 1,800 and of course exhibits water insolubility. The addition of polyoxyethylene moieties to this hydrophobic portion tends to increase the water solubility of the molecule as a whole, and the liquid character of the product is retained up to the point where the polyoxyethylene content is about 50% of the total weight of the condensation product. Examples of compounds of this type include certain of the commercially available Pluronic surfactants marketed by BASF.

Nonionic surfactants may include alcohol alkoxylates having EO, PO and BO blocks. Straight chain primary aliphatic alcohol alkoxylates can be particularly useful as non-ionic surfactants. Such alkoxylates are also available from several sources including BASF where they are known as “Plurafac” and “Pluronic” surfactants. A particular group of alcohol alkoxylates found to be useful are those having the general formula R—(EO)ₘ——(PO)ₙ wherein m is an integer from about 2 to 10 and n is an integer from about 2 to 20. R can be any suitable radical such as a straight chain alkyl group having from about 6 to 20 carbon atoms. An example of a suitable nonionic surfactant is available under the tradename Plurafac LF901 from BASF located in Germany. Such nonionic surfactants, preferably alcohol alkoxylates, are present in the invention in liquid delivery suitable for coating on a substrate an amount of up to about 40 percent by weight.

Other useful nonionic surfactants include capped aliphatic alcohol alkoxylates. These end caps include but are not limited to methyl, ethyl, propyl, butyl, benzyl and chlorine. Useful alcohol alkoxylates include ethylene diamine ethylene oxides, ethylene diamine propylene oxides, mixtures thereof, and ethylene diamine EO-PO compounds, including those sold under the tradename Tetronic. Preferably, such surfactants have a molecular weight of about 400 to 10,000. Capping improves the compatibility between the nonionic and the oxidizers hydrogen peroxide and peroxycarboxylic acid, when formulated into a single composition. Other useful nonionic surfactants are alkylpolyglycosides. The alcohol alkoxylates can be linear, branched or a combination of linear and branched. The alcohol alkoxylates can also be secondary alcohol alkoxylates. Mixtures of the above surfactants are also useful in the present invention.

Although alcohol alkoxylates are preferred, one skilled in the art will recognize that other nonionic surfactants may be incorporated into the compositions of the present invention instead of the alcohol alkoxylates. Alcohol alkoxylates are present in liquid concentrates other than those suitable for substrate coating in an amount from about 0.01 up to about 20% by weight, from about 0.05 up to about 10%, and from about 0.1 up to about 5% by weight.

Other useful nonionic surfactants can comprise a silicone surfactant including a modified dialkyl, preferably a dimethyl polysiloxane. The polysiloxane hydrophobic group is modified with one or more pendent hydrophilic polyalkylene oxide group or groups. Such surfactants provide low surface tension, high wetting, antifoaming and excellent stain removal. U.S. Pat. No. 7,199,095 incorporated herein for all purposes in its entirety teaches use of such silicone nonionic surfactants in a detergent composition. Such silicone surfactants comprise a polydialkyl siloxane, preferably a polydimethyl siloxane to which polyether, typically polyethylene oxide, groups have been grafted through a hydrosilation reaction. The process results in an alkyl pendent (AP type) copolymer, in which the polyalkylene oxide groups are attached along the siloxane backbone through a series of hydrolytically stable Si—C bond.

A second class of nonionic silicone surfactants is an alkoxy-end-blocked (AEB type) that are less preferred because the Si—O— bond offers limited resistance to hydrolysis under neutral or slightly alkaline conditions, but breaks down quickly in acidic environments.

Examples of silicone surfactants are sold under the SILWET® trademark from Momentive Performance Materials or under the TEGOPREN® trademark from Evonik Industries.

In addition to non-ionic surfactants, anionic surfactants or an anionic surfactants admixture are optionally included in liquid compositions. The term “anionic surfactant” includes any surface active substances which are categorized as anionics because the charge on the hydrophobe is negative; or surfactants in which the hydrophobic section of the molecule carries no charge unless the pH is elevated to neutrality or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and calcium, barium, and magnesium promote oil solubility.

As those skilled in the art understand, anionics are excellent detersive surfactants and are therefore, favored additions to heavy duty detergent compositions. Anionics are useful additives to compositions of the present invention. Further, anionic surface active compounds are useful to impart special chemical or physical properties other than detergency within the composition. Anionics are excellent solubilizers and can be used for hydrotropic effect and cloud point control.

The majority of large volume commercial anionic surfactants can be subdivided into five major chemical classes and additional sub-groups known to those of skill in the art and described in “Surfactant Encyclopedia,” Cosmetics & Toiletries, Vol. 104 (2) 71 86 (1989). The first class includes acylamino acids (and salts), such as acylgluamates, acyl peptides, sarcosinates (e.g. N-acyl sarcosinates), taurates (e.g. N-acyl taurates and fatty acid amides of methyl tauride), and the like. The second class includes carboxylic acids (and salts), such as alkanoic acids (and alkanoates), ester carboxylic acids (e.g. alkyl succinates), ether carboxylic acids, and the like. The third class includes phosphoric acid esters and their salts. The fourth class includes sulfonic acids (and salts), such as isethionates (e.g. acyl isethionates), alkylaryl sulfonates, alkyl sulfonates, sulfosuccinates (e.g. monoesters and diesters of sulfosuccinate), and the like. The fifth class includes sulfuric acid esters (and salts), such as alkyl ether sulfates, alkyl sulfates, and the like.

Anionic sulfate surfactants suitable for use in the present compositions include the linear and branched primary and secondary alkyl sulfates, alkyl ethoxysulfates, fatty oleyl glycerol sulfates, alkyl phenol ethylene oxide ether sulfates, the C₅ C₁₋₇ acyl-N—(C₁ C₄ alkyl) and —N—(C₁ C₂ hydroxyalkyl) glucamine sulfates, and sulfates of alkylpolysaccharides such as the sulfates of alkylpolyglucoside (the nonionic nonsulfated compounds being described herein).

Examples of suitable synthetic, water soluble anionic detergent compounds include the ammonium and substituted ammonium (such as mono-, di- and triethanolamine) and alkali metal (such as sodium, lithium and potassium) salts of the alkyl mononuclear aromatic sulfonates such as the alkyl benzene sulfonates containing from 5 to 18 carbon atoms in the alkyl group in a straight or branched chain, e.g., the salts of alkyl benzene sulfonates or of alkyl toluene, xylene, cumene and phenol sulfonates; alkyl naphthalene sulfonate, diamyl naphthalene sulfonate, and dinonyl naphthalene sulfonate and alkoxylated derivatives.

Anionic carboxylate surfactants suitable for use in the present compositions include the alkyl carboxylates, alkyl ethoxy carboxylates, and the alkyl polyethoxy polycarboxylate surfactants.

Other anionic detergents suitable for use in the present compositions include olefin sulfonates, such as long chain alkene sulfonates, long chain hydroxyalkane sulfonates or mixtures of alkenesulfonates and hydroxyalkane-sulfonates. Also included are the alkyl sulfates, alkyl poly(ethyleneoxy)ether sulfates and aromatic poly(ethyleneoxy) sulfates such as the sulfates or condensation products of ethylene oxide and nonyl phenol (usually having 1 to 6 oxyethylene groups per molecule). Resin acids and hydrogenated resin acids are also suitable, such as rosin, hydrogenated rosin, and resin acids and hydrogenated resin acids present in or derived from tallow oil.

Anionic surfactants are optionally present in liquid delivery formats. When present, anionic surfactants are preferably sodium linear alkylbenzene sulfonate or sodium lauryl sulfate, and in an amount up to about 40% by weight.

### Solvent

A solvent is useful in the composition of the invention to enhance certain soil removal properties. The compositions of the invention can contain a non-aqueous or aqueous solvent. Preferred solvents are non-aqueous oxygenated solvents. Oxygenated solvents include lower alkanols, lower alkyl ethers, glycols, aryl glycol ethers and lower alkyl glycol ethers. These materials are colorless liquids with mild pleasant odors, are excellent solvents and coupling agents and may be miscible with aqueous use compositions of the invention. Examples of useful solvents include methanol, ethanol, propanol, isopropanol and butanol, isobutanol, ethylene glycol, diethylene glycol, triethylene glycol, propylene glycol, dipropylene glycol, mixed ethylene-propylene glycol ethers, ethylene glycol phenyl ether, and propylene glycol phenyl ether. Substantially water soluble glycol ether solvents include propylene glycol methyl ether, propylene glycol propyl ether, dipropylene glycol methyl ether, tripropylene glycol methyl ether, ethylene glycol butyl ether, diethylene glycol methyl ether, diethylene glycol butyl ether, ethylene glycol dimethyl ether, ethylene glycol propyl ether, diethylene glycol ethyl ether, triethylene glycol methyl ether, triethylene glycol ethyl ether, triethylene glycol butyl ether, and others.

“Substantially water soluble” solvents are defined as being infinitely or 100% soluble by weight in water at 25 degrees C. “Substantially water insoluble” glycol ether solvents include propylene glycol butyl ether, dipropylene glycol butyl ether, dipropylene glycol propyl ether, tripropylene glycol butyl ether, dipropylene glycol dimethyl ether, propylene glycol phenyl ether, ethylene glycol hexyl ether, diethylene glycol hexyl ether, ethylene glycol phenyl ether, diethylene glycol phenyl ether, and others. “Substantially water insoluble” solvents are defined as 53% by weight or less of solvent is soluble in water at 25 degrees C. Preferred solvents are substantially water-soluble solvents. These preferred solvents help reduce surface tension, help solubilize grease, and help to maintain the cleaner as a stable single phase system. For reasons of low cost, commercial availability, high flash point, and solvent strength, diethylene glycol monobutyl ether is a preferred solvent.

In a liquid embodiment for substrate delivery, an essentially water-soluble solvent is present in the invention in an amount from about 0.05 up to about 80 percent by weight, from about 1 to 75 wt %, and from about 5 to 70 wt %. In an embodiment for liquid delivery free of a substrate, a water soluble solvent is present in the invention in an amount from about up to about 70 percent by weight, from about 1 to 50 wt %, and from about 5 to 40 wt %. In an embodiment for liquid delivery free of a substrate, a substantially water insoluble solvent is present in the invention in an amount from about up to about 40 percent by weight, from about 1 to 35 wt %, and from about 2 to 30 wt %.

Without being bound by theory, it is believed that in the present invention when coating the concentrate of the invention on a substrate is desired, the solvent is useful as an agent to allow dissolution of the concentrate from the substrate when immersed in diluent (preferably water). It was found that for embodiments of the invention where the liquid concentrate is coated on a substrate, the concentrate released significantly slower from the substrate into the water as the weight % of water soluble solvent was decreased.

### Additional Ingredients

Any number of optional ingredients may be added to the concentrate composition of the invention. If the concentrate will be diluted with hard water, as opposed to soft water, a chelating agent is a desirable optional ingredient. If a chelating agent is included, a hydrotrope is preferably included to help maintain the chelating agent in a uniform stable liquid solution before and after dilution. Additionally, a small amount of water is added in order to dilute the optional corrosion inhibitor before addition to the concentrate composition. Preservatives, fragrance and dye are examples of further ingredients that are optionally added to the concentrate composition of the invention. These additional optional ingredients are discussed in turn in more detail below.

### Hydrotrope

Hydrotropy is a property that relates to the ability of materials to improve the solubility or miscibility of a substance in liquid phases in which the substance tends to be insoluble. Substances that provide hydrotropy are called hydrotropes and are used in relatively lower concentrations than the materials to be solubilized. A hydrotrope modifies a formulation to increase the solubility of an insoluble substance or creates micellar or mixed micellar structures resulting in a stable suspension of the insoluble substance. The hydrotropic mechanism is not thoroughly understood. Apparently either hydrogen bonding between primary solvent, in this case water, and the insoluble substance are improved by the hydrotrope or the hydrotrope creates a micellar structure around the insoluble composition to maintain the material in a suspension/solution. In this invention, the hydrotropes are most useful in maintaining the formulae components in a uniform solution during manufacture and transport, and when dispensed at the use location. The amine oxide surfactant, solvent, amino alcohol, fragrance, and nonionic surfactant of the invention alone or especially when combined with the chelating agent and corrosion inhibitor, tends to be partially incompatible and can undergo a phase change or phase separation during storage of the solution. The hydrotrope solubilizer maintains a single phase solution having the components uniformly distributed throughout the composition in an aqueous or non-aqueous form.

Hydrotrope materials are relatively well known to exhibit hydrotropic properties in a broad spectrum of chemical molecule types. Hydrotropes generally include ether compounds, alcohol compounds, anionic surfactants, cationic surfactants and other materials.

Hydrotropes are used in detergent formulations to allow more concentrated formulations of surfactants. A hydrotrope is a compound that solubilizes hydrophobic compounds in aqueous solutions. Without being bound by theory, it is believed that the hydrotropes in the compositions of the invention allow salts such as the chelator salt and the corrosion inhibitor salt to be soluble in the hydrophobic components. As such, it is most useful in the compositions for liquid and substrate deliveries of the present invention. When a chelating agent is included in the composition of the present invention, a hydrotrope is desirably included. It has surprisingly been found that the amphoteric surfactant, dipropionate, is useful as a hydrotrope in the formulation of the present liquid concentrate composition. In particular, sodium laurimino dipropionate, commercially available as Mirataine H2C-HA from Rhodia Novacare is useful in the present invention. This hydrotrope is preferred because of its biodegradability and its compatibility with aqueous chelating agent solutions. When optionally present in the invention, it is present in an embodiment for delivery on a substrate in an amount of between about 0 to about 30 weight percent, between about 0.1 to about 20 weight percent, and between about 0.5 to about 5 weight percent. When present in an embodiment for liquid delivery without a substrate, it is present in an amount of between about 0.05 to about 20 weight percent, between about 0.1 to about 10 weight percent, and between about 0.5 to about 5 weight percent. It is recognized that the preferred hydrotrope of the invention is also an amphoteric surfactant, however, for purposes of this disclosure, it is not included when referring to the surfactant, the surfactant admixture, or the like.

In addition, when a chelating agent is included in the composition of the present invention, it has surprisingly been found that polyethylene glycols and polypropylene glycols, both up to a molecular weight of 1000, are useful as hydrotropes in the formulation of the present liquid concentrate composition. In particular, Polyglykol 200 from Clariant and PT250 from DOW are useful in the present invention. When the amine oxide is provided as Barlox 1260 (which contains 25% polypropylene glycol) and the hydrotrope selected is polypropylene glycol, the amount of hydrotrope provided is over and above the polypropylene glycol present in the Barlox 1260. These hydrotropes are preferred because of their commercial availability and their compatibility with aqueous chelating agent solutions. When each is optionally present in the invention, it is present in an embodiment for delivery on a substrate in an amount of between about 0 to about 20 weight percent, between about 0.1 to about 10 weight percent, and between about 0.5 to about 5 weight percent. When each is present in an embodiment for liquid delivery without a substrate, it is present in an amount of between about 0 to about 30 weight percent, between about 0.1 to about 20 weight percent, and between about 0.5 to about 10 weight percent.

In addition, when a water insoluble non-ionic surfactant is included in the composition of the present invention, it has been found that aromatic sulfonic acids or salts thereof are useful hydrotropes. Examples of such hydrotropes are xylene sulfonic acid, naphthalene sulfonic acid, cumene sulfonic acid, and toluene sulfonic acid or sodium and ammonium salts thereof. In particular, sodium xylene sulfonate, commercially available as Stepanate SXS 40% solution from Stepan is useful in the present invention. When optionally present in the invention, it is present in an embodiment for delivery on a substrate in an amount of between about 0 to about 25 weight percent, between about 0.1 to about 15 weight percent, and between about 0.5 to about 10 weight percent. When present in an embodiment for liquid delivery without a substrate, it is present in an amount of between about 0 to about 25 weight percent, more between about 0.1 to about 15 weight percent, and between about 0.5 to about 10 weight percent.

For embodiments of the invention suitable for coating on a substrate, the stability of the liquid concentrate significantly decreases as the weight % of dipropionate hydrotrope decreases.

### Sequestrant

The active cleaning compositions of the invention can comprise a polyvalent metal complexing, sequestering or chelating agent that aids in metal compound soil removal and in reducing harmful effects of hardness components in service water. Sequestrant or chelating agents may be included in any delivery format useful for concentrations of the present invention. Typically, a polyvalent metal cation or compound such as a calcium, a magnesium, an iron, a manganese, a molybdenum, etc. cation or compound, or mixtures thereof, can be present in service water and in complex soils. Such compounds or cations can comprise a stubborn soil or can interfere with the action of either washing compositions or rinsing compositions during a cleaning regimen. A chelating agent can effectively complex and remove such compounds or cations from soiled surfaces and can reduce or eliminate the inappropriate interaction with active ingredients including the nonionic surfactants and anionic surfactants of the invention. Both organic and inorganic chelating agents are common and can be used. Inorganic chelating agents include such compounds as sodium tripolyphosphate and other higher linear and cyclic polyphosphates species. Organic chelating agents include both polymeric and small molecule chelating agents. Organic small molecule chelating agents are typically organocarboxylate compounds or organophosphate chelating agents. Polymeric chelating agents commonly comprise polyanionic compositions such as polyacrylic acid compounds. Small molecule organic chelating agents include sodium gluconate, sodium glucoheptonate, N-hydroxyethylenediaminetriacetic acid (HEDTA), ethylenediaminetetraacetic acid (EDTA), nitrilotriaacetic acid (NTA), diethylenetriaminepentaacetic acid (DTPA), ethylenediaminetetraproprionic acid, triethylenetetraaminehexaacetic acid (TTHA), and the respective alkali metal, ammonium and substituted ammonium salts thereof, ethylenediaminetetraacetic acid tetrasodium salt (EDTA), nitrilotriacetic acid trisodium salt (NTA), ethanoldiglycine disodium salt (EDG), diethanolglycine sodium-salt (DEG), and 1,3-propylenediaminetetraacetic acid (PDTA), dicarboxymethyl glutamic acid tetrasodium salt (GLDA), methylglycine-N—N-diacetic acid trisodium salt (MGDA), and iminodisuccinate sodium salt (IDS). All of these are known and commercially available. Small molecule organic chelating agents also include biodegradable sequestrants having combinations of chelating and hydrotroping functionalities from EDG, MGDA and GLDA-type molecules. Preferred sequestrants include ethanoldiglycine disodium salt (EDG), dicarboxymethyl glutamic acid tetrasodium salt (GLDA), and methylglycine-N—N-diacetic acid trisodium salt (MGDA), due to their biodegradability and their ability to bind easily with hydrotropes to form ultra-compact concentrates. It has surprisingly been found that for compositions of the invention suitable for coating on substrates and for highly concentrated liquid compositions (all containing very little, if any, water), the combination of at least two different chelating agents prevents salt crystal formulation as compared to if only a single chelator salt is used in the composition.

In a liquid embodiment for substrate delivery, optional chelating agents are present in the composition concentrate in an amount of between about 0.05 and about 20 weight percent, about 2 to about 15 wt %, and about 3 to about 10 wt %. In a concentration for liquid delivery (without substrate coating), an optional chelating agents are present in the composition concentrate in an amount of between about 0.05 and about 40 weight percent, about 2 to about 15 wt %, and between about 5 to about 10 wt %.

### Corrosion Inhibitor

A corrosion inhibitor is a chemical compound that, when added in small concentrations, stops or slows down corrosion, otherwise referred to as oxidation of metals and alloys. Examples of suitable corrosion inhibitors include those that inhibit corrosion, but that do not significantly interfere with the solubilizing activity of the composition. Corrosion inhibitors which may be optionally added to the composition of the invention include silicates, phosphate, magnesium and/or zinc ions. Preferably, the metal ions are provided in a water-soluble form. Examples of useful water-soluble forms of magnesium and zinc ions are the water-soluble salts thereof including the chlorides, nitrates and sulfates of the respective metals. Some preferred corrosion inhibitors include sodium metasilicate pentahydrate, sodium bicarbonate, potassium silicate and/or sodium silicate. A preferred corrosion inhibitor useful in the present invention, regardless of delivery method, is sodium metasilicate pentahydrate. When a corrosion inhibitor is present in the invention composition suitable for substrate coating or liquid delivery, it is added in an amount of about 0.005 up to about 0.4 weight percent, about 0.01 to about 0.3 wt %, and between about 0.02 up to about 0.2 wt %. The corrosion inhibitor is substantially added in the same preferred amounts throughout the various liquid delivery embodiments of the invention.

### Dyes, Fragrances and Preservatives

Aesthetic enhancing agents such as dye and perfume are also optionally incorporated into the concentrate composition of the invention. Examples of dyes useful in the present invention include but are not limited to liquid and powdered dyes from Milliken Chemical, Keystone, Clariant, Spectracolors and Pylam. In an embodiment, Liquitint Violet 0947 commercially available from Milliken Chemical is used. In liquid and substrate-coated embodiments up to about 5 wt % is included, up to about 2.5 wt %, and up to about 2 wt %.

Examples of perfumes or fragrances useful in concentrate compositions of the invention include but are not limited to liquid fragrances from J&E Sozio, Firmenich, and IFF (International Flavors and Fragrances). In liquid and substrate-coated embodiments Orange Fragrance SZ-40173 commercially available from J&E Sozio is included up to about 5 wt %, up to about 4 wt % and up to about 2 wt %.

Preservatives are required when the concentrate and use solution pH is not high enough to mitigate bacterial growth in the concentrate, liquid, on the liquid coated substrate, or in the use solution. Examples of preservatives useful in concentrate compositions of the invention include but are not limited to methyl paraben, glutaraldehyde, formaldehyde, 2-bromo-2-nitropropane-1,3-diol, 5-chloro-2-methyl-4-isothiazoline-3-one, and 2-methyl-4-isothiazoline-3-one. Preservatives can be included up to about 2 wt %, up to about 1 wt % and up to about 0.5 wt %.

### Water

The concentrate composition of the invention is substantially nonaqueous. While it is recognized that certain ingredients may contain some amount of water because they are provided as a solution in water, the concentrate still remains substantially nonaqueous for the substrate-coated versions and highly concentrated liquid embodiments. This is important in particular when the delivery modes include coating the concentrate onto a substrate, dispensing liquid concentrates to make efficacious, but very dilute, use solutions. In the liquid substrate delivery embodiment, additional water is added only when corrosion inhibitors are included into the invention composition. A small amount of water is then added in order to solubilize the corrosion inhibitor before adding it to the concentrate. Water is optionally added in an amount up to about 3.6 wt %, up to about 1.8 wt %, and up to about 0.5 wt % in the substrate-coated delivery compositions. In the liquid delivery free of a substrate, water is added to reduce the eye and skin irritancy of the concentrate. In a liquid delivery free of a substrate, water is added in an amount up to about 15 wt %, up to about 12 wt %, and up to about 10 wt %, up to about 5 wt %, up to about 2.5 wt %, up to about 1 wt % In some embodiments (either substrate coated or non-substrate coated liquid concentrate) compositions of the invention are substantially free of any added water. By use of the term “free of any added water” it is meant that water is not added as a stand alone ingredient apart from being part of any of the chemical components of the composition.

The concentrate can be formulated without any water or can be provided with a relatively small amount of water in order to reduce the expense of transporting the concentrate. When the concentrate is provided as a liquid, it may be desirable to provide it in a flowable form so that it can be pumped or aspirated.

It should be understood that the water provided as part of the concentrate can be relatively free of hardness. It is expected that the water can be deionized to remove a portion of the dissolved solids. The concentrate is then diluted with water available at the locale or site of dilution and that water may contain varying levels of hardness depending upon the locale. Although deionized is preferred for formulating the concentrate, the concentrate can be formulated with water that has not been deionized. That is, the concentrate can be formulated with water that includes dissolved solids, and can be formulated with water that can be characterized as hard water.

Service water available from various municipalities has varying levels of hardness. It is generally understood that the calcium, magnesium, iron, manganese, or other polyvalent metal cations that may be present can cause precipitation of the anionic surfactant. In general, because of the expected large level of dilution of the concentrate to provide a use solution, it is expected that service water from certain municipalities will have a greater impact on the potential for anionic surfactant precipitation than the water from other municipalities. As a result, it is desirable to provide a concentrate that can handle the hardness levels found in the service water of various municipalities. The water of dilution that can be used to dilute the concentrate can be characterized as hard water when it includes at least 1 grain hardness. It is expected that the water of dilution can include at least 5 grains hardness, at least 10 grains hardness, or at least 20 grains hardness.

It is expected that the concentrate will be diluted with the water of dilution in order to provide a use solution having a desired level of detersive properties. If the use solution is required to remove tough or heavy soils, it is expected that the concentrate can be diluted with the water of dilution at a weight ratio of at least 1:1. If a light duty cleaning use solution is desired, it is expected that the concentrate can be diluted at a weight ratio of concentrate to water of dilution of up to about 1:1000. It is expected that the weight ratio of concentrate to water of dilution will be between about 1:1 and about 1:500, between about 1:2 and about 1:450, between about 1:3 and about 1:400, and between about 1:5 and about 1:350. In certain liquid substrate delivery applications, the concentrate can be diluted at a weight ratio of concentrate to water of dilution at about 1:50 to 1:200 by weight. In certain liquid delivery applications without substrate coating, the concentrate can be diluted at a weight ratio of concentrate to water of dilution at about 1:1 to 1:300 by weight.

The compositions may further include enzymes, enzyme stabilizing system, bleaching agents, defoamer, anti-redeposition agent, anti-microbial agents, and the like.

### Delivery Modes

The concentrate composition of the invention can be provided on a substrate as a liquid or gel. The substrate can be provided in the form of a fabric (e.g., non-woven, foam, expanded polymer, woven, or knitted) containing the cleaning composition concentrate as an impregnate or coating. The concentrate composition can additionally be provided as a liquid or gel where a sufficient amount of the concentrate composition will remain on the substrate until the substrate is introduced into a body of water such as the inside of a spray bottle.

The concentrate composition of the invention may be provided in a packaged form wherein the package is comprised of a film or capsule. The packaged composition concentrate can be placed in a water soluble film or capsule, or a non-water soluble film. In the case of a non-water soluble film, the film can be torn or cut to release the composition concentrate. The composition concentrate can then be introduced into a volume of water. For example, the composition concentrate can be poured into a container and combined with water. When the film is a water soluble film (or a water-dispersible film) or water soluble capsule, the packaged composition concentrate can be introduced into a volume of water and, with time, the film dissolves, disintegrates, or disperses, and the composition concentrate contacts the water.

The film can be provided so that it encloses or contains the cleaning composition concentrate. The film can be provided having a fold line, and can be provided having a heat seal or adhesive seal along the edges. It should be understood that the packaged concentrate can be provided without a fold line and the edges can all be heat sealed or adhesively sealed.

Non-water soluble films that can be used to hold or contain the cleaning composition concentrate include conventional films used in the packaging industry. Exemplary films that can be used include polyethylenes, polypropylenes, polybutylenes, polyesters, and polyamides.

Water soluble (or water dispersible) films or capsules that can be used include those made from water soluble polymers such as those described in Davidson and Sittig, Water Soluble Resins, Van Nostrand Reinhold Company, New York (1968), herein incorporated by reference in its entirety for all purposes. The water soluble polymers can have proper characteristics such as strength and pliability in order to permit machine handling. Exemplary water soluble polymers include polyvinyl alcohol, cellulose ethers, polyethylene oxide, starch, polyvinylpyrrolidone, polyacrylamide, polyvinyl methyl ether-maleic anhydride, polymaleic anhydride, styrene maleic anhydride, hydroxyethylcellulose, methylcellulose, polyethylene glycols, carboxymethylcellulose, polyacrylic acid salts, alginates, acrylamide copolymers, guar gum, casein, ethylene-maleic anhydride resin series, polyethyleneimine, ethyl hydroxyethylcellulose, ethyl methylcellulose, and hydroxyethyl methylcellulose. Lower molecular weight water soluble, polyvinyl alcohol film-forming polymers are generally preferred. Polyvinyl alcohols that can be used include those having a weight average molecular weight of between about 1,000 and about 300,000, and between about 2,000 and about 150,000, and between about 3,000 and about 100,000.

Exemplary water soluble packaging films are disclosed in U.S. Pat. Nos. 6,503,879; 6,228,825; 6,303,553; 6,475,977; and 6,632,785, the disclosures of which are incorporated herein by reference for all purposes in their entirety. In addition, see U.S. Pat. No. 4,474,976 to Yang, U.S. Pat. No. 4,692,494 to Sonenstein, U.S. Pat. No. 4,608,187 to Chang, U.S. Pat. No. 4,416,793 to Haq, U.S. Pat. No. 4,348,293 to Clarke, U.S. Pat. No. 4,289,815 to Lee, and U.S. Pat. No. 3,695,989 to Albert, the disclosures of which are all incorporated herein by reference for all purposes in their entirety. An exemplary water soluble polymer that can be used to package the concentrate includes polyvinyl alcohol.

In another embodiment the packaged composition concentrate includes a substrate upon which the composition concentrate is impregnated or coated and optionally includes a film for enclosing and containing the substrate and the concentrate. In the case of an enclosed substrate, when it is desirable to remove the substrate/concentrate composition from the film, one can cut or tear the top portion of the film and remove the substrate/concentrate composition there from. In an embodiment, the substrate can be provided in a form that allows a bottle dip tube to extend there through. In such an instance, the substrate can be referred to as a sleeve or as a carrier. The substrate can be provided as a laminate of a first substrate and a second substrate. The first substrate and the second substrate can be bonded at the seams to provide a sleeve through which the straw-like dip tube of a spray bottle can be inserted. A bottle dip tube can extend through the hollow opening of the sleeve. In general, the bottle dip tube refers to the tube extending from a sprayer to the bottom of a bottle, and is used to draw liquid from the bottle to the spray nozzle.

An advantage of the use of a bottle dip tube for capturing the substrate is the ability for a user to avoid touching the substrate with his or her hands. While it may be advantageous under certain circumstances to avoid touching the substrate, the composition concentrate can be provided as part of a substrate where a user can touch the substrate. That is, in an alternate embodiment, a user can simply remove the substrate from a package or container and introduce the substrate into a volume of water to generate a use composition. In addition, the substrate need not be provided in the form of a substrate having a hollow opening. Instead, the substrate can be provided having a single or multiple layer structure. For example, a user can remove the substrate from a package or container that may include multiple substrates, and then place the substrate in a container of water. While it may be desirable under certain circumstances to avoid touching the substrate, the substrate can be constructed so that it can be touched. If the substrate is damp, it may be desirable to avoid touching the substrate to reduce transfer of the concentrate to skin tissue.

Sleeves that can be used on dip tubes are useful to deliver the concentrate composition of the invention. Such sleeves may have a star shape in cross section, a diamond shape, or a triangular shape to name a few. The cross-sectional view includes the opening through which a dip tube could extend. These three dimensionally shaped non-woven substrates or sleeves can be formed to fit perfectly within a bottle's neck. This lock-out feature only allows the “star shaped” sleeve to be inserted into the “star shaped” bottle neck. The sleeves can be provided as non-woven webs. Exemplary disclosures for the manufacture of non-woven webs that can be used to form these sleeves or other sleeves having different cross-section shapes include, for example, U.S. Pat. No. 6,250,511, U.S. Pat. No. 6,576,034, U.S. Pat. No. 5,607,766, U.S. Patent Application Publication No. US2005/0189292, and U.S. Patent Application Publication No. US2005/0153132. The disclosures from each these patents and patent publications are incorporated herein by reference in their entirety for all purposes. The sleeves can be characterized as three dimensional non-wovens, wovens or knitted substrates and can be provided having wicking properties.

Alternatively, the concentrate of the invention may be coated on a woven or non-woven wick as available from Filtrona Fibertec.

In another embodiment, the liquid concentrate composition (other than those suitable for substrate coating) can be diluted through dispensing equipment using aspirators, peristaltic pumps, gear pumps, mass flow meters, and the like. This liquid concentrate embodiment can also be delivered in bottles, cartridges, jars, dosing bottles, bottles with dosing caps, and the like. The liquid concentrate composition (other than those suitable for substrate coating) can be filled into a multi-chambered or single chambered cartridge insert which is then placed in a spray bottle or other delivery device filled with a pre-measured amount of water. A cartridge chamber is then pushed open or pierced by the spray bottle's dip tube to deliver the liquid concentrate into the water which is easily dispersed to form a uniform use solution. Exemplary disclosures for the cartridge insert, its bottle and its sprayers are found in U.S. Pat. No. 6,290,100. The liquid concentrate composition (other than those suitable for substrate coating) can also be diluted at the manufacturing site and packaged as a ready-to-use (RTU) use solution.

While the invention is amenable to various modifications and alternative forms, specifics thereof have been shown by way of the Examples and will be described in detail. It should be understood, however, that the intention is not to limit the invention to the particular embodiments described. On the contrary, the intention is to cover all modifications, equivalents, and alternatives falling within the spirit and scope of the invention.

### EXAMPLES

### Accelerated Shelf Life Stability Protocol

Compositions prepared according to the Examples provided below were subjected to the following protocol to determine extended stability.

### Liquid Concentrate

Two 2 to 4 ounce samples of each of the prototype compositions is held in a stability test chamber for 6 weeks, one at 122° F. and one at 40° F. A third 2 to 4 oz. sample of the prototype composition is also placed in a 0° F. test chamber. The third sample underwent 3 freeze/thaw cycles. One freeze/thaw cycle is defined as taking the sample to 0° F. for at least 24 hours and then to an ambient temperature (between about 60 and about 80° F.) for at least 8 hours. A fourth 2 to 4 oz. sample of the prototype composition was held under ambient conditions (60-80° F.) for the duration of the stability testing, as a control for the other test conditions. The prototype composition was considered to have a 2 year shelf life if it was stable after 6 weeks at 122° F. and 40° F., and after 3 freeze/thaw cycles. A clear liquid was considered to be stable if it stayed clear when brought to ambient temperature, if it did not have any precipitate (crystalline or non-crystalline), floating material or material suspended, if it did not appreciably change color from the control ambient sample, if it remained a liquid, and if it remained in one continuous liquid phase, that is, more than one phase did not appear.

Substrate-Coated Composition Accelerated Shelf Life Stability Protocol:

For liquid compositions suitable for coating on a substrate, the following protocol was run in order to test for extended shelf life stability.

A 4 ounce sample of the prototype composition was held at ambient temperature for 24 hours. The prototype composition was considered stable for coating on a substrate if the sample stayed clear and did not have any precipitate (crystalline or non-crystalline), floating material or material suspended, and if it remained a liquid in one continuous liquid phase (i.e., did not phase split), and if it did not appreciably change color as compared to its freshly made sample for 24 hours at ambient temperature.

The liquid composition for coating on a substrate was then packaged in a pail, drum, tote or holding tank within 24 hours of manufacture. Prior to coating on a substrate (within 24 hours of coating), the liquid was agitated for 30 minutes. At this point the liquid to be coated on a substrate was considered stable if any precipitate, floating material, suspended material, or discontinuous liquid phases were mixed back into one clear continuous liquid phase after a 30 minute mix. Additionally, the packaged liquid's color did not appreciably change from the color of a freshly made prototype sample.

Three coated substrates containing a prototype composition were then individually packaged in a film/foil container and each was held in a stability test chamber for 6 weeks, one at each of the following conditions: 122° F., 40° F. and 0° F. A fourth substrate-coated prototype, packaged in a film/foil container, was also held under ambient conditions for the duration of the stability testing, as a control for the other test conditions.

The substrate-coated prototype was considered to have a 2 year shelf life if it was stable after 6 weeks at 122° F., 40° F. and 0° F. The prototype composition was considered stable if (1) when mixed with the designated dilution water it delivered a clear use solution with no precipitate, floating material, suspended material, or discontinuous liquid phases; and (2) after analyzing the resulting use solution via standard chemical analysis methods the pre-coated liquid prototype's chemical composition matched the use solution taking into account the added water for the use solution dilution.

### Example 1

A liquid concentrate composition suitable for coating on a substrate was prepared according to the present invention using the amounts and ingredients listed in Table 1A and Table 1B below.

A composition was prepared according to the formulation provided in Table 1. A premix was first prepared:

TABLE 1A
Premix

| Chemical | Category | Percent by Weight |
|---|---|---|
| Water, Zeolite softened | Water | 90.00 |
| Sodium Metasilicate | Corrosion Inhibitor | 10.00 |

TABLE 1B

| | | | % by |
|---|---|---|---|
| Chemical | Category | Tradename | weight |
| Methylglycine-N- | Chelating agent | BASF Trilon M, | 6.30 |
| N-diacetic acid, | | 40% liquid | |
| 40% solution | | | |
| (MGDA) | | | |
| Disodium ethanol | Chelating agent | Dow HEIDA or | 1.00 |
| diglycinate, 28% | | Akzo Nobel EDG | |
| solution (EDG) | | | |
| Premix | Corrosion Inhibitor | See table above | 0.44 |
| Sodium Laurimino | Hydrotrope | Mirataine H2C-HA | 2.70 |
| Dipropionate, | | | |
| 29.5% solution | | | |
| Amine oxide - 60% | Surfactant | Lonza Barlox 1260* | 68.80 |
| actives | | | |
| Amino methyl | Alkalinity source | Unger AMP-95 | 4.70 |
| propanol - 95% | | | |
| solution | | | |
| Diethylene glycol | Solvent | Dow Butyl Carbitol | 14.12 |
| monobutyl ether | | | |
| Long chain alcohol | Surfactant | BASF Plurafac | 0.86 |
| alkoxylate | | LF901 | |
| Orange fragrance | Fragrance | Orange SZ-40173 | 0.98 |
| Violet liquid dye | Dye | Liquitint Violet | 0.10 |
| | | 0947 | |

The premix in Example 1 is made by dissolving the sodium metasilicate in the water. The aqueous sodium metasilicate solution is then mixed with the MGDA and EDG. The dipropionate is then mixed well into the MGDA/EDG/metasilicate solution. In a separate container, the AMP-95 is mixed with the Barlox 1260. The Butyl Carbitol is then mixed well into the Barlox 1260/AMP solution. The Plurafac LF901 is then mixed well into the Barlox 1260/AMP/Butyl Carbitol solution. The MGDA/EDG/metasilicate/dipropionate solution is then mixed well into the Barlox 1260/AMP/Butyl Carbitol/Plurafac LF901 solution. The fragrance and dye are then mixed into the solution. Example 1 solution is mixed for 30 minutes or until uniform.

The concentrate composition prepared according to Tables 1A and 1B was coated onto a nonwoven web substrate available from Pacon. Non-woven webs are available from a number of sources such as PGI, BBA, Fiberweb and Texel. An amount of 6.25 grams concentrate was coated onto a 2 gram weight nonwoven web having dimensions 1 inch×8 inches. Once loaded, the nonwoven web had 65.4% actives coated onto it which is suitable for diluting into 24 ounces water. A container was then filled with 24 ounces of water having from 3 to 35 grains of hardness, and the coated nonwoven web was placed into the water. The concentrate composition quickly dispersed from the nonwoven web and a substantially clear use composition was prepared. The use composition was then sprayed through a spray bottle or placed dropwise alongside the control degreaser, Titan™ (commercially available from Ecolab of St. Paul, Minn.) at a 1:9 dilution by volume, and left to sit for 1.5 minutes onto a variety of fresh and spent kitchen fats, greases and oils, placed on a hard surface comprised of stainless steel. After 1.5 minutes had elapsed the soil was gently rinsed with cold water. The panel was allowed to dry. The relative soil removal was compared with the control's cleaning performance on the same panel. The use composition of this Example 1 and the control degreaser were effective at degreasing/cleaning 100% of spent animal fats, hydrogenated oils and polyunsaturated oils from the stainless steel hard surface.

The composition of Example 1 was submitted to the Substrate-Coated Accelerated Shelf Life Stability Protocol outlined above. The composition passed all of the stability tests. That is, the liquid composition was stable for 24 hours before coating on the substrate. After standing for 24 hours any precipitate or suspended material in the liquid was completely mixed back into solution after 30 minutes of mixing. The substrate-coated samples passed all of the 6 week stability tests. Use solutions prepared from the substrate-coated samples were clear and the use solution's contents corresponded to the original pre-coated liquid prototype's chemical composition, taking into account the added water to make the use solution.

### Example 2

An alternate liquid embodiment of the concentrate composition suitable for coating on a substrate or as a stand alone liquid concentrate according to the present invention was prepared using the amounts and ingredients listed in Table 2 below.

TABLE 2

| Chemical | Category | Tradename | % by weight |
|---|---|---|---|
| Amino methyl | Alkalinity | Unger AMP-95 | 9.4675 |
| propanol - 95% | source | | |
| solution | | | |
| Long Chain | Nonionic | BASF Plurafac LF | 4.7337 |
| alkoxylated alcohol | Surfactant | 901 | |
| Diethylene glycol | Solvent | Dow Butyl Carbitol | 68.0609 |
| monobutyl ether | | | |
| Amine oxide - 60% | Surfactant | Lonza Barlox 1260 | 16.6479 |
| actives | | | |
| Orange Fragrance | Fragrance | J&E Sozio SZ 40173 | 0.9900 |
| Violet liquid dye | Dye | Liquitint Violet 0947 | 0.1000 |

The concentrate in Example 2 is made by mixing AMP-95 into the Barlox 1260. Then, the Plurafac LF 901 is added and mixed well. Next, the Butyl Carbitol is added and mixed well. The fragrance and dye are then mixed into the solution. Example 2 solution is mixed for 30 minutes or until uniform.

The concentrate composition prepared according to Table 2 was coated onto a nonwoven web substrate available from Pacon. Non-woven webs are available from a number of sources such as PGI, BBA, Fiberweb and Texel. An amount of 6.25 grams concentrate was coated onto a 2 gram weight nonwoven web having dimensions 1 inch×8 inches. Once loaded, the nonwoven web had 92.9% actives coated onto it which is suitable for diluting into 24 ounces water. A container was then filled with 24 ounces of water having from 3 to 35 grains of hardness, and the coated nonwoven web was placed into the water. The concentrate composition quickly dispersed from the nonwoven web and a substantially clear use composition was prepared. The use composition was then sprayed through a spray bottle or placed dropwise alongside the control degreaser, Titan™ degreaser at a 1:9 dilution by volume, and left to sit for 1.5 minutes onto a variety of fresh and spent kitchen fats, greases and oils, placed on a hard surface comprised of stainless steel. After 1.5 minutes had elapsed the soil was gently rinsed with cold water. The panel was allowed to dry. The relative soil removal was compared with the control's cleaning performance on the same panel. The use composition of this Example 2 was effective at degreasing/cleaning 50% of spent animal fats, and 100% of hydrogenated oils and polyunsaturated oils from the stainless steel hard surface, whereas the control was effective at degreasing/cleaning 100% of spent animal fats, and 100% of hydrogenated oils and polyunsaturated oils from the stainless steel hard surface.

In an alternative test instead of coating on a substrate, 6.25 grams of the composition prepared according to this Example 2 was placed directly in 24 ounces of water having from 3 to 35 grains of hardness. The concentrate composition quickly dissolved and a substantially clear use composition was prepared. Cleaning results were consistent with those described according to the substrate-coated composition in the preceding paragraph. The liquid concentrate was subjected to the liquid accelerated shelf life stability protocol outlined above. Based upon the results, all compositions from this Example 2 were found to have at least a 2 year shelf life.

The composition of Example 2 was also submitted to the Substrate-Coated Accelerated Shelf Life Stability Protocol outlined above. The composition passed all of the stability tests. That is, the liquid composition was stable for 24 hours before coating on the substrate. After standing for 24 hours any precipitate or suspended material in the liquid was completely mixed back into solution after 30 minutes of mixing. The substrate-coated samples passed all of the 6 week stability tests. Use solutions prepared from the substrate-coated samples were clear and the use solution's contents corresponded to the original pre-coated liquid prototype's chemical composition, taking into account the added water to make the use solution.

### Example 3

Compositions were prepared according to the formulations provided in Table 3 below. Such compositions are useful for delivery as a liquid free of substrate coating.

This Example demonstrates the flexibility of the invention in providing different concentrations of formulae according to the invention.

TABLE 3

| | | | Concentration | | | | |
|---|---|---|---|---|---|---|---|
| | | | 10x | 12x-A | 12x-B | 12.7x | 12.9x |
| Chemical | Category | Tradename | Wt. % | Wt. % | Wt, % | Wt. % | Wt. % |
| Methylglycine- | Chelating | BASF Trilon | 5.7208 | 5.8301 | 5.8301 | 6.1670 | 6.2624 |
| N-N-diacetic | Agent | M, 40% | | | | | |
| acid, 40% | | liquid | | | | | |
| solution | | | | | | | |
| (MGDA) | | | | | | | |
| Disodium | Chelating | Dow HEIDA | 0.9081 | 0.9254 | 0.9254 | 0.9789 | 0.9940 |
| ethanol | Agent | or Akzo | | | | | |
| diglycinate, | | Nobel EDG | | | | | |
| 28% solution | | | | | | | |
| (EDG) | | | | | | | |
| Sodium | Corrosion | Sodium | 0.0400 | 0.0407 | 0.0407 | 0.0431 | 0.0437 |
| Metasilicate | Inhibitor | metasilicate | | | | | |
| 5H₂O | | | | | | | |
| Sodium | Hydrotrope | Rhodia | 2.4518 | 2.4986 | 1.0000 | 2.6430 | 2.6839 |
| Laurimino | | Mirataine | | | | | |
| Dipropionate, | | H2C- | | | | | |
| 29.5% solution | | HA/McIntyre | | | | | |
| | | Mackam | | | | | |
| | | 168L | | | | | |
| Amine oxide - | Surfactant | Lonza | 62.4744 | 63.6689 | 63.6689 | 67.3476 | 68.3897 |
| 60% actives | | Barlox* | | | | | |
| Amino methyl | Alkalinity | Unger AMP- | 4.2679 | 4.3495 | 4.3495 | 4.6008 | 4.6720 |
| propanol - 95% | Source | 95 | | | | | |
| solution | | | | | | | |
| Diethylene | Solvent | Dow Butyl | 12.8218 | 13.0669 | 13.0669 | 13.8219 | 14.0358 |
| glycol | | Carbitol | | | | | |
| monobutyl | | | | | | | |
| ether | | | | | | | |
| Long chain | Surfactant | BASF | 0.7809 | 0.7959 | 0.7959 | 0.8418 | 0.8549 |
| alcohol | | Plurafac | | | | | |
| alkoxylate | | LF901 | | | | | |
| Orange | Fragrance | Orange SZ- | 0.8899 | 0.9069 | 0.9069 | 0.9593 | 0.9742 |
| fragrance | | 40173 | | | | | |
| liquid dye | Dye | Liquitint | 0.0908 | 0.0925 | 0.0925 | 0.0979 | 0.0994 |
| | | Violet 0947 | | | | | |
| | | and/or | | | | | |
| | | Liquitint | | | | | |
| | | Blue HP | | | | | |
| | | and/or | | | | | |
| | | Chromatint | | | | | |
| | | Red 1064 | | | | | |
| Dilution | | | 9.5538 | 7.8245 | 9.3231 | 2.4987 | 0.990 |
| Water, Zeolite | | | | | | | |
| softened | | | | | | | |

*Note: Lonza Barlox 1260 is a mixture of 3 amine oxides in water and polypropylene glycol. Barlox 1260 contains: 41.4% Dimethyl dodecyl amine oxide, 15% Dimethyl tetradecyl amine oxide, 3.6% Dimethyl hexadecyl amine oxide, 25% polypropylene glycol (CAS# 25322-69-4) and 15% water.

The compositions provided in Table 3 were prepared according to the protocol provided in Example 1 above. In order to prepare a use solution from the 10× composition, 11.43 g of the 10× concentrate is added to 1 liter of water. In order to prepare a use solution with either of the 12x-A or 12x-B compositions, 9.52 grams of either concentrate is placed in 1 liter of water. In order to prepare a use solution with the 12.7× concentrate, 9.00 grams of 12.7× concentrate is added to 1 liter of water. Finally, in order to prepare a use solution with the 12.9× concentrate 8.863 grams of the 12.9× concentrate is added to 1 liter of water. The use compositions or use solutions of this Example 3 were tested according to the protocol outlined in Example 1 above. Each of the use solutions was effective at degreasing/cleaning 100% of spent animal fats, hydrogenated oils and polyunsaturated oils from the stainless steel hard surface.

Each of the compositions from Table 3 were subjected to the accelerated shelf life stability protocol outlined above. Based upon the results, all compositions from this Example 3 were found to have at least a 2 year shelf life.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

We claim:

1. A substantially nonaqueous concentrate composition, comprising:
(a) an amine oxide surfactant,
(b) a substantially water-soluble solvent,
(c) a source of alkalinity,
(d) substantially free of water, and
wherein the concentrate composition is substantially water soluble and is useful in preparing a stable, aqueous use solution.

2. The composition of claim 1 further comprising any one or combination of (a) at least two different chelating agents and a hydrotrope, (b) corrosion inhibitor, (c) dye, or (d) perfume.

3. The composition of claim 1 further comprising a nonionic surfactant.

4. The composition of claim 4 wherein the composition is coated on a substrate before preparing a use solution.

5. The composition of claim 1 further wherein the substrate is comprised of a nonwoven web, a woven web, or a water soluble film.

6. The composition of claim 1 wherein the amine oxide surfactant is comprised of lauryl dimethyl amine oxide.

7. The composition of claim 3 wherein the nonionic surfactant is comprised of at least one long chain alkoxylated alcohol.

8. The composition of claim 1 wherein the solvent is comprised of diethylene glycol monobutyl ether.

9. The composition of claim 1 wherein the source of alkalinity is comprised of 2-amino-2-methyl-1-propanol.

10. The composition of claim 2 wherein the hydrotrope is comprised of sodium laurimino dipropionate.

11. The composition of claim 2 wherein the at least two chelating agents are comprised of methylglycine-N—N-diacetic acid trisodium salt and ethanoldiglycine disodium salt.

12. The composition of claim 2 wherein the corrosion inhibitor is comprised of sodium metasilicate pentahydrate.

13. A substantially nonaqueous concentrate composition, comprising:
(a) 60 to 75 wt % amine oxide,
(b) 8-20 wt % substantially water-soluble solvent,
(c) 3-10 wt % alkalinity source,
(d) 5-10 wt % chelating agent,
(e) 0.5-5 wt % hydrotrope,
(f) less than 10 wt % water, and
wherein the concentrate composition is substantially water soluble and is useful in preparing an aqueous use solution

14. The composition of claim 13 further comprising a nonionic surfactant.

15. The composition of claim 13 wherein the nonionic surfactant is comprised of a long chain alkoxylated alcohol.

16. The composition of claim 13 further comprising a corrosion inhibitor.

17. The composition of claim 13 wherein the composition contains up to about 2.5 wt % water.

18. The composition of claim 13 where the concentrate is stable for greater than 1 year.

19. The composition of claim 13 wherein the composition contains up to about 1.0 wt % water.

20. A substantially nonaqueous concentrate composition, comprising:
(a) 10 to 20 wt % amine oxide,
(b) 50 to 75 wt % substantially water-soluble solvent,
(c) 5 to 15 wt % alkalinity source,
(d) 0.1 to 7 wt % nonionic surfactant,
(e) substantially free of water, and
the concentrate composition is water soluble and is useful in preparing a stable aqueous use solution.

21. The composition of claim 20 further comprising any one or combination of (a) a chelating agent and a hydrotrope, (b) corrosion inhibitor, (c) dye, or (d) perfume.

22. The composition of claim 20 wherein the composition is coated on a substrate before preparing a use solution.

23. The composition of claim 22 further wherein the substrate is comprised of a nonwoven web, a woven web, or a water soluble film.

24. The composition of claim 20 wherein the concentrate is stable for greater than 1 year.

25. The composition of claim 20 wherein the concentrate is stable for greater than 6 months.

26. The composition of claim 13 wherein the concentrate is stable for greater than 6 months.
